(19) United States
(12) Patent Application Publication
(10) Pub. No.: US 2005/0152937 A1
(43) Pub. Date: Jul. 14, 2005

(54) Cockcroach bait jelly

(76) Inventor: Haojan Lin, Taipei (TW)

Correspondence Address: HungChang Lin, 8 Schindler Ct., Silver Spring, MD, 20903, US

(21) Appl. No.: 10/754,385

(22) Filed: Jan. 12, 2004

(51) Int. Cl. A01N 65/00; A01N 25/00; A01N 25/08; A01N 37/34

(52) U.S. Cl. 424/410; 514/65; 514/520

(57) ABSTRACT

Higher content of Low Methoxyl Pectin (LMP) is used to form jelly bait for carrying insecticide to kill cockroaches. The LMP jelly bait benefits from maintaining its softness for longer periods of time which result in high yield in killing cockroaches. The LMP jelly bait can be injected with a syringe into the crevices where the female cockroaches and nymphs hide to achieve the best effect in eradication of cockroaches

### BACKGROUND OF THE INVENTION

(1) Field of the Invention

This invention relates to insecticides, particularly a bait jelly suitable for syringe injection into crevices for cockroaches to consume the insecticide.

(2) Brief Description of Related Art

Cockroaches are fond of hiding in crevices. Cockroaches' killers found in the market such as cockroach traps can selectively kill the male cockroaches roaming about for food, but not the female cockroaches and nymphs which tend to hide and feed in the crevices without coming out. Even using spraying type insecticides, the effective dosage of insecticides which would reach to the bottom of the crevices is limited, and the result is unsatisfactory. This traditional method again kills mostly the male cockroaches, but the females and nymphs remain alive, hence ineffective. To be effective, the female and the nymphs must be eradicated in a way to inject jelly bait into the crevice where the female and the nymphs are hiding out. The application of the syringe injection has been the focus of recent development technique. Such techniques aim at killing cockroaches during their different stages of life cycles.

One technique was disclosed by U.S. Pat. No. 6,007,832. The technique uses a sticky jelly for carrying the poison to kill the cockroaches. However, the Disclosed jelly solidifies with time, until then, the poison takes no longer effect to kill the cockroaches.

### SUMMARY OF THE INVENTION

An object of the invention is to provide an insecticide for killing the cockroaches hiding in crevices. Another object is to provide a poison for injecting into the crevices where cockroaches hide. Still another object of this invention is to provide a sticky jelly for holding the poison for longer periods of time to avoid drying out.

These objects are achieved by providing the bait for cockroaches. The bait is in the form of jelly which can be injected into the crevices where the cockroaches hide out. The bait is composed of: a jelly, the food-based bait, group II metal composite with two valence metal ions, insecticide and water. The jelly has a composition which does not become hardened with time and hence longer lasting.

### EXAMPLE I

Using boric acid as principal insecticide:

| | Weight % | Weight % |
|---|---|---|
| | Concentration | concentration Allowed |
| Low Methoxyl Pectin, LMP | 0.8% | 0.6%˜10% |
| Food-based Bait | 1.0% | 0.5%˜2% |
| CaCl₂ | 1000 ppm | 50-3000 ppm |
| Boric acid | 30% | 20%-60% |
| Water | 68.2% | appropriate amount to |
| | | jellify |

Test of Cockroach: Stipella longipalpa

Test of Effectiveness:
A. Equipment: Bait box 25×15×17 cm³, screened to prevent cockroaches from climbing out.
B. Method:
   I. Load 1.5 gram tested jelly bait in a plastic petri dish and place inside the bait box. Also place food and water in the bait box near where cockroaches may hide.
   II. Put a cockroach doped with carbon dioxide in the test box and let the cockroach to eat freely for eight consecutive days. The mortality rate is recorded.

C. Results:

| | Days after feeding | | | | | | | |
|---|---|---|---|---|---|---|---|---|
| | 1 | 2 | 3 | 4 | 5 | 6 | 7 | 8 |
| Death Rate (%) | 3.3 ± 5.8 | 13.3 ± 15.3 | 30.0 ± 10.0 | 33.3 ± 5.8 | 53.3 ± 5.8 | 70.0 ± 0.0 | 96.7 ± 5.8 | 100 ± 0.0 |

### EXAMPLE II

Using chlorpyrifos as principal insecticide: The ingredients are as follows:

| | Weight % | Weight % |
|---|---|---|
| | Concentration | Concentration allowed |
| Low Methoxyl Pectin, LMP | 0.8% | 0.6%˜10% |
| Food-based Bait | 1.0% | 0.5%˜2% |
| CaCl₂ | 1000 ppm | 50-3000 ppm |
| Chlorpyrifos | 2% | 0.5%˜3% |
| Water, H₂O | 96.2% | appropriate amount to |
| | | jellify |

The test method is the same as Example I. The results are as follows:

| | Days after feeding | | | | | | | |
|---|---|---|---|---|---|---|---|---|
| | 1 | 2 | 3 | 4 | 5 | 6 | 7 | 8 |
| Death Rate (%) | 43.3 ± 5.8 | 63.3 ± 5.8 | 96.7 ± 5.8 | 100 ± 0.0 | XX | XX | XX | XX |

The food-based bait used in our tests is water soluble and dissolved easily without affecting jellification after the introduction of CaCl₂ into the pectin solution. There are many kinds of food-based bait well known in prior art. The jelly bait of the present invention can contain food baits like onion, milk powder, flour, sugar, meat etc. without affecting ability to jellify. Based on our observation, different kinds of cockroaches such as Periplaneta Americana, Blattella germanica or Periplaneta brunnea do not differ significantly in their preference of bait. They all prefer jelly type baits with high water content. Therefore, the tested results should be applicable to any other kinds of cockroaches.

Boric acid has been known for its low solubility in water and the delayed action as an insecticide. The killing mechanism can be divided into two categories. The first category is to kill by contact and requires over 40% suspended content in the jelly to be effective. The second category is to kill by intake and requires 10-40% suspend content in the jelly. The cockroaches would die one to eight days after intake.

Chlorpyrifos is an organic phosphate. Due to low insect repellent property, it is widely used as a low toxicity insecticide. It is available in the market with 40.8% concentration soluble in water and can be mixed with pectin solution to form milky gel. Such an insecticide has faster action, commonly with 1-2% dosage. Cockroaches usually die in 2-3 days after intake.

### EXAMPLE III

Low methoxyl pectin-amidated, LMPA.

To prepare pectin-mediated jelly bait, the LMP can also be replaced with Low methoxyl pectin-amidated, LMPA, with other ingredients remain unchanged. The LMPA can be obtained through amidated process to the the carboxy group in LMP to become LMPA. The LMPA can also jellify in the presence of II valence metal ion similar to LMP. The advantage over LMP is that the melting point of the jelly is higher up to 150° C., whereas the LMPA jelly would melt at 75° C. At pH value below 3.4, the hardness of the LMPA jelly is higher than that of LMP jelly.

While the preferred embodiments of the art have been described, it will be apparent to those skilled in the art that various modifications can be made in the embodiments without departing from the spirit of the present invention. Such modifications are all within the scope of this invention.

1. An insecticide jelly bait for cockroaches comprising:
a pectin selected from the group consisting of: low methoxyl pectin (LMP), and low methoxyl pectin-amidated (LMPA);
a food-based bait;
composite with II valence metal ion selected from the group consisting of magnesium ion calcium ion, strontium ion, and barium ion;
an insecticide selected from the group consisting of boric acid, organic phosphate, and synthesized chrysanthemum essence; and water.

2. The insecticide jelly bait as described in claims 1, wherein said LMP has a weight percentage of 0.6% to 10%.

3. The insecticide as described in claim 1, wherein said LMPA has a weight percentage of 0.6% to 10%.

4. The insecticide jelly bait as described in claim i, wherein said food-based bail has a weight percentage of 0.5% to 2%.

5. The insecticide jelly bait as described in claim 1, wherein said composite with II valence metal ion has a weight percentage of 50 ppm to 3000 ppm;

6. The insecticide jelly bait as described in claim 1, wherein said boric acid has a weight percentage of 20% to 60%.

7. The insecticide jelly bait as described in clairm 1, wherein the organic phosphate has a weight percentage of 0.5% to 3%.

8. The insecticide jelly bait as described in claim 1, wherein the organic phosphate is selected from the group consisting of: Chlorpyrifos, Fenitrothion, Fenthion, Malathion, Pirimiphos-Methyl and Temphos.

9. The insecticide jelly as described in claim 1, wherein the synthesized chrysanthemum essence is selected from the group consisting of: Bioresnethrin, Cypermethrin, Deltamethrin, Permethrin, Phenothrin, Resmethrin, S-Bioallethrin and Tetramethrin.
